(19) United States
(12) Patent Application Publication
(10) Pub. No.: US 2006/0164090 A1
(43) Pub. Date: Jul. 27, 2006

(54) Inspection apparatus

(76) Inventor: Claude Poletti, Paris Cedex (FR)

Correspondence Address: YOUNG & THOMPSON, 745 SOUTH 23RD STREET, 2ND FLOOR, ARLINGTON, VA, 22202, US

(21) Appl. No.: 10/538,936

(22) PCT Filed: Dec. 10, 2003
(86) PCT No.: PCT/EP03/15023

§ 371 Date: Mar. 16, 2006

(30) Foreign Application Priority Data
Dec. 11, 2002 (FR) 02/15647

(51) Int. Cl. G01V 3/00

(52) U.S. Cl. 324/323

(57) ABSTRACT

The present invention relates to inspection reports for certifying that a particular event has actually taken place at a particular date or time, and, where appropriate, at a particular place. The invention provides an inspection apparatus (100) including, in a secure casing, a central processing unit (1), a digital audiovisual device (2) such as a camera and/or a video camera and/or a sound recorder, a clock (3), and a watermarker (4) capable of embedding temporal information provided by the clock (3) in the data stream coming from the audiovisual device (2). The apparatus (100) may include, in addition to the above-mentioned devices and depending upon the application envisaged, supplementary incorporated measuring instruments providing digital data, in particular a geographic position measuring device (5) such as a GPS.

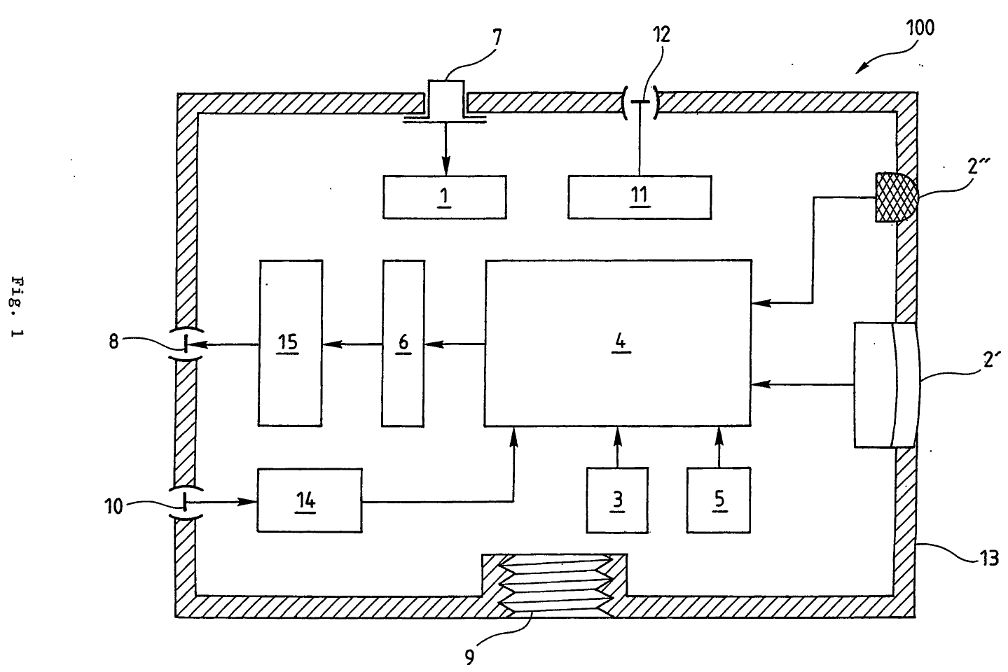

The present invention relates to inspection reports for certifying that a particular event has actually taken place at a particular date or time, and, where appropriate, at a particular place.

The need for such inspection reports frequently occurs in a large number of technical or commercial activities. Here are a few examples: a constructor of buildings or of transport infrastructure needs to verify the progress of works; a boilermaker needs to verify that the current process for manufacturing parts actually corresponds to specification; a cableway maintenance company needs to be able to prove that a required repair has actually been carried out at the set date at the top of a pylon; an airport runway maintenance company needs to study the deterioration of the runways caused by a succession of airplane landings; subsequent to a road accident, the police needs to record the state of the roadway and of the vehicles involved in the accident; a distributor of perishable foodstuffs needs to verify the correct storage of those foodstuffs; a copyright defense association needs to prove that a particular musical work was played without authorization in a particular public place.

For such applications, an expert is conventionally called upon, which has a certain number of drawbacks, in particular:

1) the fees and traveling expenses of the expert are high;

2) the limited number of experts and the time they need to travel from one point to another for their work leads to long delays between the request for an inspection and obtaining its result;

3) the expert must frequently manipulate a certain number of precision instruments, giving rise to the possibility of human errors in the manipulation of those instruments; and

4) in certain cases, the good faith of the expert may be subject to doubt, particularly when the person or legal entity employing him has an economic interest in the result of the inspection.

The invention therefore concerns the possibility of performing inspections while avoiding the aforementioned drawbacks.

The invention thus concerns an inspection apparatus comprising, in a secure casing:

a central processing unit,

at least one digital audiovisual device,

a clock, and

a watermarker capable of embedding the temporal information provided by said clock in the data stream coming from said audiovisual device.

By virtue of the invention, a human expert can advantageously be replaced by the apparatus succinctly described above, the manipulation of which may be performed by a person who is not a chartered professional and who does not necessarily have the technical knowledge required to perform an inspection. This is because the device, once positioned and triggered, automatically provides dated audiovisual recordings, which may for example be photographs and/or video films and/or sound recordings. Furthermore, the apparatus according to the invention may comprise, in addition to the above-mentioned devices and depending upon the application envisaged, supplementary incorporated measuring instruments providing digital data.

The secure casing of the apparatus according to the invention may advantageously be constructed so as to be practically tamper proof. This is because all the devices and instruments mentioned above may be triggered by remote control, or by a button situated on the surface of the secure casing; moreover, the digital format of the data enables them to be extracted using some particular secure method, without the casing of the apparatus having to be opened. Thus, the measurements made by the apparatus are all authenticated, and the data provided, in particular at the moment at which an audiovisual recording was made, are absolutely certified by their being embedded within the data stream of that recording.

Furthermore, the precision of the measurements carried out by the instruments incorporated in the apparatus may easily exceed that which a human expert can provide. Finally, the apparatus according to the invention is capable of simultaneously making several data recordings, which becomes physically impossible for a human expert as from the moment when, say, more than three simultaneous recordings must be made.

It is clear that the distribution of apparatuses according to the invention over a chosen territory will rapidly enable an inspection to be made at any desired location of that territory. The data recorded by each apparatus may easily be extracted from it, then transmitted to the one commissioning for the inspection via some secure channel.

According to particular features, the apparatus according to the invention may further comprise a device for measuring the geographic position of the apparatus, and the watermarker mentioned above is capable of embedding the information provided by that geographic position measuring device in the data stream coming from the audiovisual device. This geographic position measuring device may advantageously be a receiver forming part of a universal locating system such as GPS (Global Positioning System).

According to other particular features, the apparatus according to the invention further comprises a distance measuring device, for example a laser transmitter/receiver. The distance measuring device for example makes it possible to measure the distance between the apparatus according to the invention and a succession of points sighted by a photographic lens incorporated into the apparatus. From such a succession of measurements the dimensions of a photographed object can in particular be deduced.

According to still more particular features, the apparatus according to the invention further comprises a thermal probe. This thermal probe makes it possible for example to remotely measure the temperature of a photographed object, for example cast parts.

According to still more particular features, the apparatus according to the invention further comprises an inclinometer. The inclinometer makes it possible to measure the inclination of the apparatus according to the invention with respect to the horizontal before taking measurements.

According to still more particular features, the apparatus according to the invention further comprises an electronic compass. The compass makes it possible to measure the orientation of the apparatus according to the invention with respect to magnetic North before taking measurements.

According to still more particular features, the apparatus according to the invention further comprises at least one connector enabling an external source of secure data to be attached. This may for example be a GPS receiver situated at some distance from the apparatus according to the invention when the reception of the GPS signal at the exact location of the apparatus is too poor.

Other aspects and advantages of the invention will emerge from a reading of the following detailed description of embodiments, given by way of non-limiting example. This description refers to the single attached drawing, which very schematically represents an apparatus according to a specific embodiment of the invention.

The FIGURE represents an inspection apparatus 100 according to an embodiment of the invention.

The apparatus 100 is constituted by a group of units contained in a very robust rigid casing 13, which an ill-intentioned person can only open with great difficulty, and, the case arising, only by destroying a substantial portion of said units. The closing 13 is provided with a connector 9 adapted for the attachment of a stand (not shown) enabling the apparatus 100 to be positioned at the required height and to incline it according to needs. The items of equipment contained in the apparatus 100 are powered by an electric accumulator 11, of which the connections with the other items of equipment contained in the casing 13 have not been represented in order to simplify the drawing. This accumulator 11 may be recharged using the connector 12.

In accordance with the invention, the apparatus 100 comprises a CPU (Central Processing Unit) of which the connections with the other items of equipment contained in the casing 13 have not been represented in order to simplify the drawing. The CPU 1 is associated with a programmed ROM (Read Only Memory). The apparatus 100 is activated by powering up the CPU 1 by means of a switch 7; in a variant, remote triggering could be provided for, utilizing for example infrared radiation.

In accordance with the invention, apparatus 100 comprises digital audiovisual devices, here two of them, which are a camera 2′ (comprising a lens, a shutter, a CCD sensor, and an image processing circuit) and a microphone 2″ provided with a analog/digital converter.

In accordance with the invention, the apparatus 100 also comprises a clock 3.

Among the measuring instruments which may be incorporated into the apparatus 100, it will often be useful to have available a device 5 for measuring geographic location, such as a GPS receiver. It may be recalled that a GPS receiver manages the data received from terrestrial satellites, and that this system enables geographic position to be obtained with the precision of a meter after waiting for a period of the order of a minute. In order to ensure an optimum reception quality, it is recommended to provide the GPS receiver with an antenna (not represented) integrated into the external surface of the casing 13. It will be noted that the GPS system also provides the date and the time, such that when an apparatus according to the invention is designed with a GPS, the corresponding part of the GPS receiver may conveniently be taken as a clock 3 without duplicating that clock function.

Moreover, the apparatus 100 is provided with at least one connector 10 enabling an external source of data to be attached (not shown). To protect against any attempt at fraud, the data provided by that external source of data are verified at the input to the device 100 by a logic unit 14, by means of a conventional secure method, using for example a password.

All the digital data so collected are directed to a watermarker 4. In accordance with the invention, the watermarker 4 embeds the temporal information provided by said clock 3 in the data stream coming from the audiovisual devices (here 2′ and 2″). The watermarker 4 does the same in the data stream coming, the case arising, from the various measuring instruments (here a GPS). By additional precaution, it is recommended to include in the watermarker 4 a device enabling that embedding to be encrypted by known means.

The stream so obtained is then stored in a RAM (random access memory). This RAM 6 is followed by a logic unit 15 leading to a connector 8 for the extraction of the data stored in the RAM 6. The function of that logic unit 15 is to authorize the extraction of the data only by duly authorized persons. For this a conventional secure method will be used, for example using a password.

In order to produce an inspection apparatus 100 that is as compact and light as possible, a bay may be provided within the casing 13 into which a series of plug-in electronic cards may be inserted depending on the intended applications, before closing and sealing the casing 13. For example the following devices could be provided in electronic card form: the central processing unit 1, the image processing circuit for the camera 2′ or for a video camera, the analog/digital converter for the microphone 2″, the watermarker 4, and the RAM 6; the same applies to the GPS signal processing circuit, or to a clock 3 if the apparatus 100 does not include a GPS receiver. As for the other possible measuring instruments (distance measuring device, thermal probe, inclinometer, electronic compass etc.), these may conveniently comprise an analog data acquisition board connected to an analog/digital converter.

1. Inspection apparatus (100) comprising, in a secure casing:
a central processing unit (1),
at least one digital audiovisual device (2),
a clock (3), and
a watermarker (4) capable of embedding the temporal information provided by said clock (3) in the data stream coming from said audiovisual device (2).

2. Apparatus according to claim 1, characterized in that said audiovisual device (2) is a camera.

3. Apparatus according to claim 1, characterized in that said audiovisual device (2) is a video camera.

4. Apparatus according to claim 1, characterized in that said audiovisual device (2) is a sound recorder.

5. Apparatus according to claim 1, characterized in that it further comprises a device (5) for measuring the geographic position of the apparatus, and in that said watermarker (4) is capable of embedding the information provided by said geographic position measuring device (5) in the data stream coming from the audiovisual device (2).

6. Apparatus according to claim 5, characterized in that said geographic position measuring device (5) is a receiver forming part of the GPS system.

7. Apparatus according to claim 1, characterized in that it further comprises a distance measuring device.

8. Apparatus according to claim 1, characterized in that it further comprises a thermal probe.

9. Apparatus according to claim 1, characterized in that it further comprises an inclinometer.

10. Apparatus according to claim 1, characterized in that it further comprises an electronic compass.

11. Apparatus according to claim 1, characterized in that it further comprises at least one connector (10) enabling an external source of secure data to be attached.
